(19) United States
(12) Patent Application Publication
(10) Pub. No.: US 2004/0189095 A1
(43) Pub. Date: Sep. 30, 2004

(54) Integrated power supply for an LCD panel

(76) Inventors: Yung-Lin Lin, Palo Alto, CA (US); Da Liu, San Jose, CA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/397,023

(22) Filed: Mar. 25, 2003

(51) Int. Cl. H02J 1/00

(52) U.S. Cl. 307/43; 307/11

(57) ABSTRACT

The present invention provides an integrated LCD panel power supply formed on a single printed circuit board. The integrated power supply includes at least one DC/AC control unit, at least one DC/DC buck converter unit and at least one DC/DC boost control unit. Each unit supplies power to an associated function of said LCD. The integrated power supply may also include an oscillator circuit generating a clock signal, and the clock signal is supplied to each unit thereby synchronizing the operation of each unit. The single PCB approach of the present invention eliminates the need for additional wiring between printed circuit boards and thereby eliminates or substantially reduces noise issues associated with such wiring.

### FIELD OF THE INVENTION

The present invention relates to a power supply for an LCD panel display, and more particularly, to an integrated LCD panel power supply that utilizes a single printed circuit board (PCB) for all of the power function of the LCD panel, and a single clock generator for synchronizing all the power functions of an LCD panel.

### BACKGROUND OF THE INVENTION

FIG. 1 depicts a conventional power supply system 10 for an LCD panel 34. In the conventional system 10, at least three separate PCBs are used to provide different power supply functions. PCB1 (12) is provided to include a DC/AC converter 18 that generates an AC signal to supply power to one or more cold-cathode fluorescent lamps (CCFLs) 20. PCB2 (14) include a DC/DC switching converter and linear converter 22 to generate DC power supply voltages for various parts of the system 10, including a microcontroller 24. The microcontroller is used, for example, as the master controller for the LCD panel functions. A third PCB, PCB3 (16) is provided for the graphics processing of the LCD panel. PCB3 typically includes a graphic data processor 26 a DC/DC switching converter and linear converter 28 to generate DC power supply voltages for a TFT LCD source driver circuit 30 and a TFT LCD gate driver circuit 32. In this conventional system, wiring is required between each of the three PCBs. Such wiring is susceptible to noise and interference from the LCD panel or other sources, which can affect the performance of the LCD panel. Also, three separate PCBs increases the overall cost of the panel and increases the number of components required to generate the required power for the LCD panel functions.

### SUMMARY OF THE INVENTION

In one aspect, the present invention provides an LCD panel power supply, comprising a single printed circuit board comprising at least one DC/AC control unit, at least one DC/DC buck converter unit and at least one DC/DC boost control unit. Each unit supplies power to an associated function of the LCD panel.

In another aspect, the present invention provides an LCD panel power supply, comprising a single printed circuit board comprising at least one DC/AC control unit, at least one DC/DC buck converter unit and at least one DC/DC boost control unit. Each unit supplies power to an associated function of the LCD panel. The power supply also includes an oscillator circuit generating a clock signal, the clock signal is supplied to each unit thereby synchronizing the operation of each unit.

In yet another aspect, the present invention provides an LCD panel power supply, comprising a single printed circuit board comprising at least one DC/AC control unit, at least one DC/DC buck converter unit and at least one DC/DC boost control unit and LCD gate and source drivers power supply control units. Each unit supplies power to an associated function of the LCD panel.

In still another aspect, the present invention provides an integrated circuit that includes a bias and reference signal generator, an oscillator, at least one DC/AC inverter controller, at least one DC/DC buck regulator controller, a DC/DC boost regulator controller, and a linear regulator for controlling the power for LCD panels.

It will be appreciated by those skilled in the art that although the following Detailed Description will proceed with reference being made to preferred embodiments and methods of use, the present invention is not intended to be limited to these preferred embodiments and methods of use. Rather, the present invention is of broad scope and is intended to be limited as only set forth in the accompanying claims.

Other features and advantages of the present invention will become apparent as the following Detailed Description proceeds, and upon reference to the Drawings, wherein like numerals depict like parts, and wherein:

### BRIEF DESCRIPTION OF THE DRAWINGS

FIG. 1 is a conventional power supply system for an LCD panel; and

FIG. 2 is an exemplary power supply system for an LCD panel of the present invention.

### DETAILED DESCRIPTION OF EXEMPLARY EMBODIMENTS

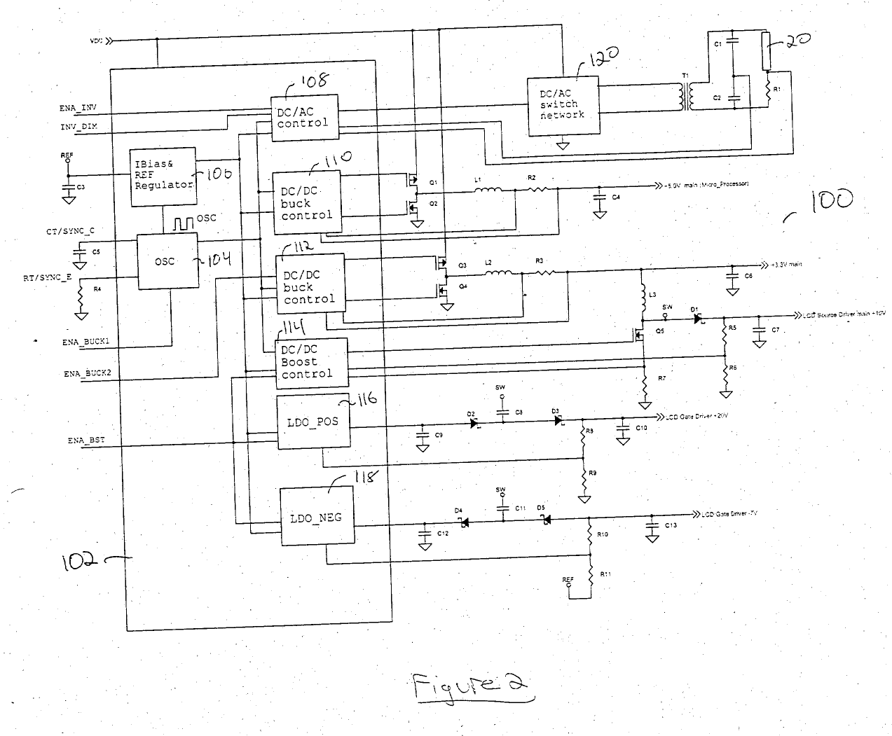

FIG. 2 is an exemplary power supply system 100 for an LCD panel of the present invention. In the exemplary system, a single integrated circuit 102 is used for all the power supply functions of the LCD panel. Additionally, a single oscillator may be used to synchronize all the power supply functions of the LCD panel. Those skilled in the art will recognize that the implementation of FIG. 2 significantly saves in cost, materials and surface area as opposed to conventional LCD power supply approaches. Additionally, the integrated circuit (IC) 102 of FIG. 2 may by mounted on a single PCB, and thus, the implementation of FIG. 2 is less prone to cross noise due to cabling between PCBs as in the conventional approach.

In the exemplary system 100, IC 102 is used to host the power requirements of the LCD panel. A DC/AC inverter controller 108 is provided as a conventional and/or proprietary inverter system to generate control signals to a switch network 120 to supply power to one or more CCFL lamps 20. The inverter controller can include an inverter controller such as the OZ960, OZ961, OZ970, OZ969A, OZ971, OZ9RR, manufactured by O2Micro International Limited, and/or other inverter controller topologies known in the art, which may comprise full bridge, half bridge, push-pull and/or other switch network topologies known in the art. A first DC/DC buck controller 110 is provided to control a buck switch network (switches Q1 and Q2) in a manner well known in the art to generate a power supply (e.g. 5V) that may be used, for example, by a microprocessor associated with the power supply depicted in FIG. 2. A second buck controller 112 is provided to control a buck switch network (switches Q3 and Q4) to generate a power supply (e.g., 3.3V) for an LCD column and row drivers (not shown). Buck controllers 110 and 112 are well known topologies and may comprise custom and/or off-the-shelf components. A boost controller 114 is provided to control a boost circuit that includes a switch Q5 to generate a step-up supply voltage (e.g., 10V). LCD power switch drivers LDO_POS 116 and LDO_NEG 118 are provided to supply power to an LCD gate and source drivers with, for example, +20V and −7V, respectively.

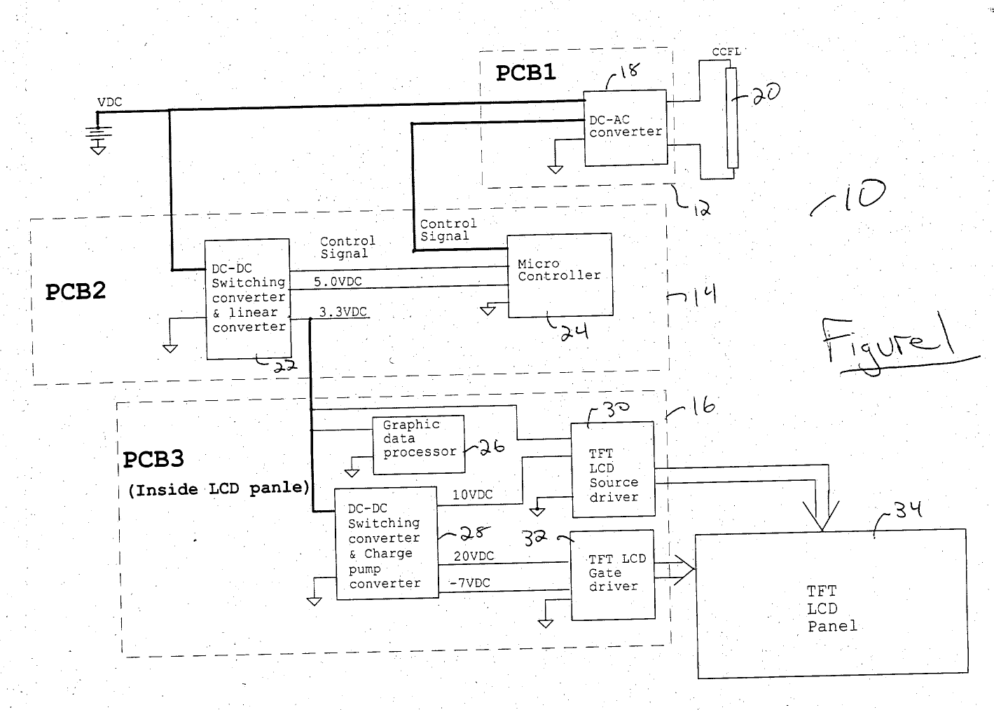

Advantageously, in the present invention, the power supply units that require a clock, e.g., power supply units 108-114, can be synchronized. An oscillator circuit 104 is provided as a clock for each of the controller units 108-114. The oscillator circuit generates a clock pulse to each of the power supply control units 108-114. Additionally, each of the power supply control units 108-118 can be provided with a common bias signal and reference signal, via a bias a reference signal generator circuit 106 commonly tied to the power supply units. Thus, the clock, bias and reference signals can be supplied to various power supply units of the IC 102 without requiring additional wiring between PCBs as depicted in FIG. 1.

Thus, it is evident that there has been provided an integrated power supply system for an LCD panel display. There is also provided an integrated power supply system for an LCD panel display that can be implemented on a single PCB. Those skilled in the art will recognize numerous modifications to the present invention. For example, the IC 102 of FIG. 2 may instead be implemented as a plurality of discrete components as shown inside the IC 102 of FIG. 2, and all the selected components can be implemented on a single PCB, Other modifications will become apparent to those skilled in the art, all of which are deemed within the spirit and scope of the present invention, only as limited by the appended claims.

1. An LCD panel power supply, comprising a single printed circuit board comprising at least one DC/AC converter unit, at least one DC/DC buck converter unit and at least one DC/DC boost converter unit, wherein each said unit supplying power to an associated function of said LCD.

2. An LCD panel power supply as claimed in claim 1, further comprising LCD gate driver and source driver power supply control units.

3. An LCD panel power supply as claimed in claim 1, further comprising an oscillator circuit generating a clock signal, said clock signal being supplied to each said unit thereby synchronizing the operation of each said unit.

4. An LCD panel power supply as claimed in claim 2, further comprising a bias signal and reference signal generator circuit supplying a common bias signal and reference signal to each said unit.

5. An LCD panel power supply, comprising a single printed circuit board comprising at least one DC/AC converter unit, at least one DC/DC buck converter unit and at least one DC/DC boost converter unit, wherein each said unit supplying power to an associated function of said LCD; further comprising an oscillator circuit generating a clock signal, said clock signal being supplied to each said unit thereby synchronizing the operation of each said unit.

6. An LCD panel power supply as claimed in claim 5, further comprising LCD gate driver and source driver power supply control units.

7. An LCD panel power supply as claimed in claim 6, further comprising a bias signal and reference signal generator circuit supplying a common bias signal and reference signal to each said unit.

8. An LCD panel power supply, comprising a single printed circuit board comprising at least one DC/AC converter unit, at least one DC/DC buck converter unit and at least one DC/DC boost converter unit and LCD gate driver and source driver power supply control units, wherein each said unit supplying power to an associated function of said LCD panel.

9. An LCD panel power supply as claimed in claim 8, further comprising an oscillator circuit generating a clock signal, said clock signal being supplied to said at least one DC/AC control unit, at least one DC/DC buck converter unit and at least one DC/DC boost control unit thereby synchronizing the operation of each said unit.

10. An LCD panel power supply as claimed in claim 8, further comprising a bias signal and reference signal generator circuit supplying a common bias signal and reference signal to each said unit.

11. An integrated circuit for controlling power to an LCD panel, comprising a bias and reference signal generator, an oscillator, a DC/AC inverter controller, a DC/DC buck regulator controller, a DC/DC boost regulator controller, and a linear regulator.
